(19) United States
(12) Patent Application Publication
(10) Pub. No.: US 2008/0266419 A1
(43) Pub. Date: Oct. 30, 2008

(54) METHOD AND APPARATUS FOR AUTOMATICALLY CONTROLLING THE DECISIVE MOMENT FOR AN IMAGE ACQUISITION DEVICE

(75) Inventors: Alexandru Drimbarean, Galway (IE); Eran Steinberg, San Francisco, CA (US)

Correspondence Address: FotoNation;Patent Legal Dept., 3099 Orchard Drive, San Jose, CA, 95134, US

(73) Assignee: FotoNation Ireland Limited, Galway (IE)

(21) Appl. No.: 12/112,586

(22) Filed: Apr. 30, 2008

Related U.S. Application Data
(60) Provisional application No. 60/914,962, filed on Apr. 30, 2007.

(51) Int. Cl. H04N 5/235; G06K 9/00

(52) U.S. Cl. 348/229.1; 382/118; 348/169; 382/103; 348/E05.034; 348/E05.043

(57) ABSTRACT

A method is operable in an image acquisition device for controlling an instant of exposure. A face is detected in a first image a scene, and further images are acquired substantially of the same scene. When a new face is detected in at least one of the further images, then a final image of the scene is acquired.

### PRIORITY

This application claims the benefit of priority under 35 USC 119(e) to U.S. provisional patent application No. 60/914,962, filed Apr. 30, 2007. This application also claims the right of priority under 35 USC 365(a) to PCT application no. PCT/EP2008/001510, filed Feb. 26, 2008.

### BACKGROUND

The present invention relates to a method and apparatus for controlling the moment of exposure of an image acquisition device, particularly using face tracking technology.

Image acquisition devices may include self-timers for delaying the instant of exposure. Activation of the timer causes an image to be taken after a predetermined time period, thereby enabling the photographer to depress a button for initiating an image acquisition sequence, and still have time to move and be present in the scene prior to acquisition. PCT Application No. PCT/US2006/030315 and U.S. published applications Nos. 2007/0201724, 2007/0201725 and 2007/0201726 disclose techniques for controlling image acquisition based on image quality and/or an analysis of content within a scene. For example, an image acquisition system may determine not to acquire an image if a person is blinking, frowning and/or is significantly occluded. In addition, an advantageous technique may involve acquisition of an image of insufficient quality in combination with fixing the problem by substituting pixels from stored images such as preview, postview or other reference images such from an image store of recognizable faces. U.S. Pat. No. 6,301,440 also suggests an image acquisition device wherein the instant of exposure is controlled by image content.

It is desired to have a method and apparatus for controlling the instant of exposure of an image acquisition device.

### SUMMARY OF THE INVENTION

A method is provided that is operable in an image acquisition device for controlling a decisive moment of exposure including determining a change in a monitored scene by addition of a new face in the scene, and then automatically acquiring an image of the scene.

Another method is provided that is operable in an image acquisition device for delaying an instant of exposure including detecting a new face in a monitored scene and only then automatically acquiring an image of the scene.

Another method is provided that is operable in an image acquisition device for controlling an instant of exposure. A face is detected in a first image a scene, and further images are acquired substantially of the same scene. When a new face is detected in at least one of the further images, then a final image of the scene is acquired.

Another method is provided that is operable in an image acquisition device for controlling an instant of exposure. A face is detected in a first image a scene, and further images are acquired substantially of the same scene. The face is tracked within the further images. When a new face is detected in at least one of the further images, then a final image of the scene is acquired.

Any of these method may further include:
(i) tracking said one or more new faces through one or more of said further images of said scene,
(ii) determining that said one or more new faces have become substantially stationary within said scene, and
(iii) delaying until said face are determined to have become substantially stationary before acquiring said final image; and/or
(i) tracking said one or more new faces through one or more of said further images of said scene;
(ii) determining that said one or more new faces are now located in a predefined region of said scene, and
(iii) delaying until said one or more new faces are determined to be located within said predefined region of said scene before to acquiring said final image; and/or
(i) determining that said one or more faces present in said first image and said one or more new faces are each smiling; and
(ii) postponing acquisition of said final image until said one or more faces present in said first image and said one or more new faces are each determined to be smiling; and/or
(i) determining that said one or more faces present in said first image and said one or more new faces are each not blinking; and
(ii) postponing acquisition of said final image until said one or more faces present in said first image and said one or more new faces are each determined to be not blinking; and/or
(i) determining that at least one of said one or more faces present in said first image and said one or more new faces comprises a known face; and
(ii) postponing acquisition of said final image until said at least one of said one or more faces present in said first image and said one or more new faces is determined to comprise said known face.

The determining may include detecting any faces present in the first image. The determining may also include detecting one or more faces present in an image acquired prior to the first image; and tracking the one or more faces through one or more further images of the scene including the first image.

Another method is provided that is operable in an acquisition device for controlling an instant of exposure. A face is detected in a first image of a scene, and further images are acquired substantially of the same scene. A instant of exposure of a final image is postponed until a predefined number of new faces appear in a subsequently acquired image of the scene.

A computer program product includes computer program code operable in an image acquisition device to perform any of the methods described above or below herein.

An image acquisition device includes a controller and one or more computer readable media for programming a processor to perform any of the methods described above or below herein.

### BRIEF DESCRIPTION OF THE DRAWINGS

Embodiments will now be described, by way of example, with reference to the accompanying drawings, in which:

FIG. 1 is a block diagram of a digital camera operating in accordance with certain embodiments; and

FIG. 2 is a flow diagram of a method according to certain embodiments.

### DETAILED DESCRIPTION OF THE EMBODIMENTS

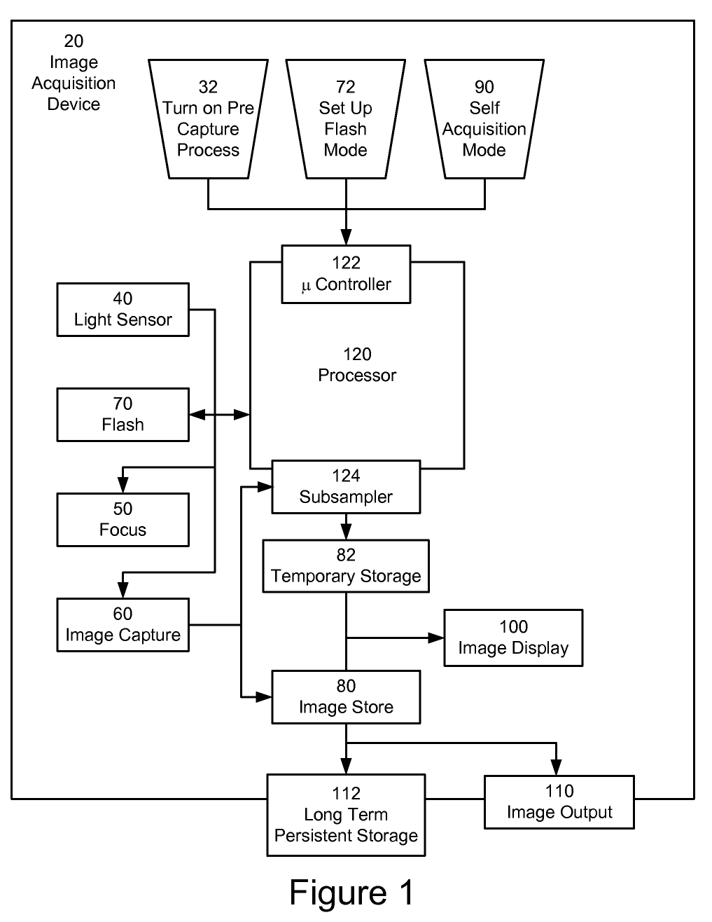

FIG. 1 is a block diagram of an image acquisition device 20, which in the present embodiment is a portable digital camera, operating in accordance with certain embodiments. It will be appreciated that many of the processes implemented in the digital camera are implemented in or controlled by software operating on a microprocessor, central processing unit, controller, digital signal processor and/or an application specific integrated circuit, collectively depicted as processor 120. All user interface and control of peripheral components such as buttons and display is controlled by a microcontroller 122. In a normal mode of operation, the processor 120, in response to a user input at 122, such as half pressing a shutter button (pre-capture mode 32), initiates and controls the digital photographic process. Ambient light exposure is determined using a light sensor 40 in order to automatically determine if a flash is to be used. The distance to the subject is determined using a focusing mechanism 50 which also focuses the image on an image capture device 60. If a flash is to be used, processor 120 causes a flash device 70 to generate a photographic flash in substantial coincidence with the recording of the image by the image capture device 60 upon full depression of the shutter button. The image capture device 60 digitally records the image in color. The image capture device is known to those familiar with the art and may include a CCD (charge coupled device) or CMOS to facilitate digital recording. The flash may be selectively generated either in response to the light sensor 40 or a manual input 72 from the user of the camera. The high resolution image recorded by image capture device 60 is stored in an image store 80 which may comprise computer memory such a dynamic random access memory or a non-volatile memory. The camera is equipped with a display 100, such as an LCD, for preview images.

In the case of preview images which are generated in the pre-capture mode 32 with the shutter button half-pressed, the display 100 can assist the user in composing the image, as well as being used to determine focusing and exposure. Temporary storage 82 is used to store one or plurality of the stream of preview images and can be part of the image store 80 or a separate component. The preview image is usually generated by the image capture device 60. For speed and memory efficiency reasons, preview images usually have a lower pixel resolution than the main image taken when the shutter button is fully depressed, and are generated by sub-sampling a raw captured image using software 124 which can be part of the general processor 120 or dedicated hardware or combination thereof.

According to an embodiment, the device 20 further comprises a module 90 for providing a mode of operation enabling a camera user to reliably capture himself or herself within an image of a scene, referred to hereafter as self-acquisition mode. The module 90 comprises software/firmware for detecting, tracking, recognising faces, or combinations thereof, within acquired digital images of an image stream, such as a preview image stream. PCT Application No. PCT/EP2007/005330 discloses such functionality and its method of application, which is utilised in accordance with certain embodiments. However it will be appreciated that any suitable means of detecting, tracking, recognising faces, or combinations thereof, within acquired digital images of an image stream may be used.

In an embodiment, the module 90 is in communication with an image acquisition trigger, for example a shutter button when the device is set to self-acquisition mode, known also as self-timer mode, and herein referred to as “face-timer” mode to thereby control an instant of exposure of the acquisition device. Control of the instant of exposure may be carried out according to the following embodiments.

Certain embodiments enable a user establishing an image of a scene on an image acquisition device, to be present in the scene prior to acquisition of an image of the scene. On setting the device to this face-timer mode, the camera detects none or a number and/or location of one or more, or any, faces present in the scene, and waits for a new face to appear in the scene. Thus, using the module 90 of the device, the device postpones the instant of exposure until a new face is detected in the scene. The mode may also work when no faces are initially detected but a new face (most likely but not limited tot he photographer) enters the frame.

Furthermore, in an embodiment, the device detects and tracks any new face appearing in the scene and postpones the instant of exposure until that face is stationary.

Furthermore, in an embodiment, the face may be determined as not only being stationary but specifically looking at the camera as opposed to facing sideways. Various other criteria may be determined. It may be determined whether faces are smiling, blinking and/or are significantly occluded, and/or that faces are looking at the camera, and/or that eyes are looking at the camera even if the faces are not angled towards the camera.

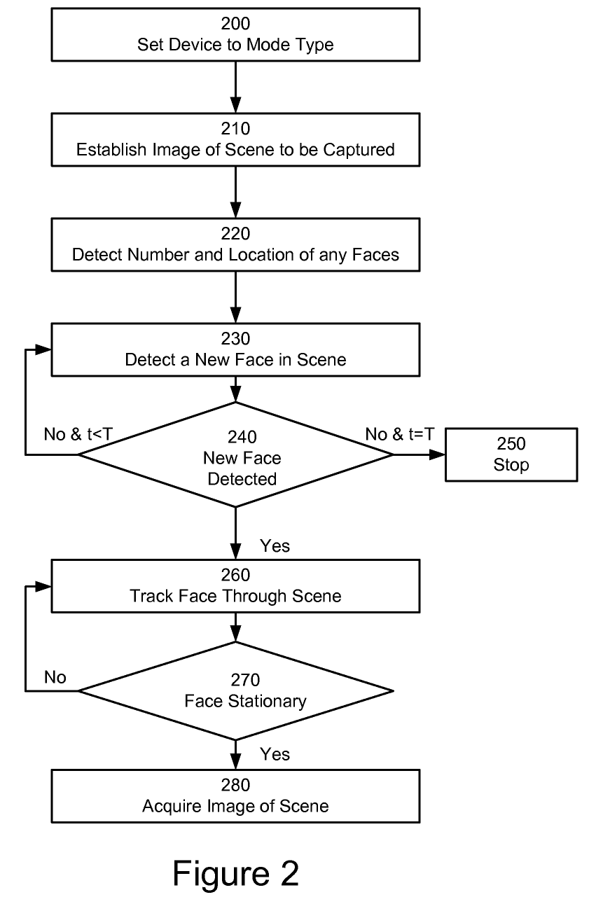

Referring now to FIG. 2, a user sets the image acquisition device to self acquisition mode 200 and establishes an image of a scene thereon 210.

Using module 90, the device detects a number and location of any faces in the image of the scene 220. This can be done by specifically detecting faces in an image of the scene acquired around the instant the device is set to self-acquisition mode, or the faces could have been detected earlier in a preview stream and tracked to their location within an image of the scene acquired prior to when the device is set to self-acquisition mode. Faces which are detected and/or tracked can be delineated by bounding boxes in display 100 both before and after selection of self-acquisition mode, to assist the user in composing the image. Again, the detection of the position as well as tracking of a detected face is preferably carried out as disclosed in PCT Application No. PCT/EP2007/005330.

The device then performs face tracking and detection 230 on the preview image stream until a new face is detected 240 within an image of the stream. Preferably face detection is carried out until a new face is detected or alternatively until a specified length of time T has expired 250. In the latter case, to ensure that a picture is taken even if the device failed to detect a new face, the device may either trigger the acquisition of a final image of the scene or indicate, for example, by beeping, that a final image of the scene will not be acquired or combination thereof

Once a new face is detected 240, the device tracks the face through subsequently acquired preview images of the scene 260.

Preferably, once the face is stationary for a predefined amount of time 270, the device triggers the acquisition of a final image of the scene 280.

Alternatively, the device tracks any new face appearing in the scene and can be set to postpone the instant of exposure until that face is located in a predefined region of said scene. This region can be user defined through interaction with the device on initially selecting self-acquisition mode; or selection of the region can be automatic by for example selecting a location between or in the vicinity of faces initially detected at step 220.

It will be appreciated that once the face is stationary for a predetermined amount of time, the device may postpone further the acquisition of an image depending on the image content of the scene, e.g., are faces smiling, are eyes blinking, are significant faces occluded or looking away. Acquisition may be postponed until a specific action transpires, for example, the acquisition of the image may be postponed until all faces in the scene are smiling. Alternatively, the acquisition of the image may be postponed until all eyes of the faces are open, i.e., not blinking.

The number of new faces expected to appear in the scene prior to the acquiring of the image can be user specified.

Furthermore, the module 90 may include a library of known faces that may be utilised such that the device is capable of postponing the instant of exposure until a known face, e.g., of a user-specified person, appears in the scene.

Furthermore, using such a library of known faces, known faces detected in the scene may be identified.

Furthermore, the system may determine that a face detected in step 220 has left the scene or is at least no longer detected in a later image and/or during tracking of the face. Due to this, the device may postpone an instant of exposure regardless of the presence of the new expected face until that detected face reappears in the scene. Such a postponing of an instant of exposure may be based on an expected number of faces for the scene or a requirement of specific known faces from the library to be present in the scene. So, for example, if a photographer is setting up a group photograph including N identified and possibly recognised faces, it is possible that in taking their position, the photographer may briefly occlude one or more of the N faces with that face re-appearing soon afterwards, but before the photographer turns to face the camera. It is therefore important that face tracking and recognition be suitably adapted to take into account such circumstances in determining when to acquire a final image. So for example, a final image might not be captured in this case until the photographers face is detected, recognised and stationary within a scene, possibly regardless of the state of other faces being tracked and/or recognised.

The above embodiments have been described in terms of a handheld digital image acquisition device, however, it will be seen that the invention is not so limited. For example, the invention could be implemented in static devices, including a kiosk incorporating a camera or a security camera. In the latter case, the security camera could stay in low resolution, power and frame-rate until it detects a face and then change to a higher resolution mode to take high quality images that can be used for face recognition.

In the case of a kiosk, it could be particularly useful in a passport or ID card mode, to acquire the final image only when there is just one face in the scene, with face being frontal and not smiling or blinking.

All references cited herein, in addition to that which is described as background, the invention summary, the abstract, the brief description of the drawings and the drawings, are hereby incorporated by reference into the detailed description of the preferred embodiments as disclosing alternative embodiments.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

In addition, in methods that may be performed according to the claims below and/or preferred embodiments herein, the operations have been described in selected typographical sequences. However, the sequences have been selected and so ordered for typographical convenience and are not intended to imply any particular order for performing the operations, unless a particular ordering is expressly provided or understood by those skilled in the art as being necessary.

1. A method operable in an image acquisition device for controlling a decisive moment of exposure including determining a change in a monitored scene by addition of a new face in the scene, and then automatically acquiring an image of the scene.

2. A method operable in an image acquisition device for delaying an instant of exposure including detecting a new face in a monitored scene and only then automatically acquiring an image of the scene.

3. A method operable in an image acquisition device for controlling an instant of exposure comprising:
acquiring a first image of a scene to be captured;
determining one or more faces present in said first image;
acquiring one or more further images nominally of said scene; and
responsive to detection of a predefined number of one or more new faces in at least one of said one or more further images, acquiring a final image of said scene.

4. A method operable in an image acquisition device for controlling an instant of exposure comprising:
acquiring a first image of a scene to be captured;
determining one or more faces present in said first image;
subsequently acquiring one or more further images nominally of said scene;
tracking in said one or more further images said one or more faces determined as being present in said first image; and
responsive to detection of a new face in at least one of said one or more further images, acquiring a final image of said scene.

5. The method of claim 3, further comprising tracking in one or more of said further images said one or more faces determined as being present in said first image

6. The method of claim 3, further comprising:
(i) tracking said one or more new faces through one or more of said further images of said scene,
(ii) determining that said one or more new faces have become substantially stationary within said scene, and
(iii) delaying until said one or more faces are determined to have become substantially stationary before acquiring said final image.

7. The method of claim 3, further comprising:
(i) tracking said one or more new faces through one or more of said further images of said scene;
(ii) determining that said one or more new faces are now located in a predefined region of said scene, and
(iii) delaying until said one or more new faces are determined to be located within said predefined region of said scene before acquiring said final image.

8. The method of claim 3, further comprising:
(i) determining that said one or more faces present in said first image and said one or more new faces are each smiling; and
(ii) postponing acquisition of said final image until said one or more faces present in said first image and said one or more new faces are each determined to be smiling.

9. The method of claim 3, further comprising
(i) determining that said one or more faces present in said first image and said one or more new faces are each not blinking; and
(ii) postponing acquisition of said final image until said one or more faces present in said first image and said one or more new faces are each determined to be not blinking.

10. The method of claim 3, further comprising:
(i) determining that at least one of said one or more faces present in said first image and said one or more new faces comprise a known face; and
(ii) postponing acquisition of said final image until said at least one of said one or more faces present in said first image and said one or more new faces is determined to comprise said known face.

11. The method of claim 3, further comprising
(i) determining that said one or more faces present in said first image and said one or more new faces are not looking away from the image acquisition device; and
(ii) postponing acquisition of said final image until said one or more faces present in said first image and said one or more new faces are each not looking away from the device.

12. The method of claim 3, further comprising
(i) determining that only one face is present in said first image and said one face is neither blinking, nor frowning, nor looking away from the image acquisition device; and
(ii) postponing acquisition of said final image until only said one face is present in said first image and said one face is neither blinking, nor frowning, nor looking away from the image acquisition device.

13. The method of claim 3, wherein said determining comprises detecting any faces present in said first image.

14. The method of claim 1, wherein said determining comprises detecting one or more faces present in an image acquired prior to said first image; and tracking said faces through one or more further images of said scene including said first image.

15. A method operable in an acquisition device for controlling an instant of exposure, comprising:
acquiring a first image of a scene to be captured;
determining one or more faces present in said first image; and
postponing an instant of exposure of a final image until a predefined number of new faces appear in a subsequently acquired image of said scene.

16. The method of claim 15, wherein said determining comprises detecting any faces present in said first image.

17. The method of claim 15, wherein said determining comprises detecting one or more faces present in an image acquired prior to said first image; and tracking said faces through one or more further images of said scene including said first image.

18. A computer program product comprising computer program code operable in an image acquisition device to perform the method of any of claims 1-17.

19. An image acquisition device, comprising a controller and one or more computer readable media for programming a processor to perform the method of any of claims 1-17.

20. An image acquisition device according to claim 19, comprising a handheld image acquisition device, a portable digital camera, a kiosk including a camera or a security camera, or combinations thereof.
